(19) United States
(12) Patent Application Publication
(10) Pub. No.: US 2006/0047135 A1
(43) Pub. Date: Mar. 2, 2006

(54) Process for preparing chloromethyl di-tert-butylphosphate

(76) Inventors: Scott T. Chadwick, Redwood City, CA (US); Kenneth A. Haines, Syracuse, NY (US)

Correspondence Address: STEPHEN B. DAVIS;BRISTOL-MYERS SQUIBB COMPANY, PATENT DEPARTMENT, P O BOX 4000, PRINCETON, NJ, 08543-4000, US

(21) Appl. No.: 11/206,318

(22) Filed: Aug. 17, 2005

Related U.S. Application Data
(60) Provisional application No. 60/605,934, filed on Aug. 30, 2004.

(51) Int. Cl. C07F 9/02

(52) U.S. Cl. 558/117

(57) ABSTRACT

A process is provided for preparing chloromethyl di-tert-butylphosphate (an intermediate for use in preparing water-soluble azole antifungal compounds), wherein potassium di-tert-butylphosphate is reacted with chloromethyl chlorosulfate under mild conditions (15 to 25° C.) in the presence of a base such as sodium carbonate or potassium carbonate, catalyst such as tetrabutylammonium sulfate or tetrabutylammonium chloride and an organic solvent such as dichloromethane or tetrahydrofuran. A process for preparing an azole antifungal agent employing the chloromethyl di-tert-butylphosphate (prepared in accordance with the present invention) is also provided.

### FIELD OF THE INVENTION

This application claims a benefit of priority from U.S. Provisional Application No. 60/605,934, filed Aug. 30, 2004, the entire disclosure of which is herein incorporated by reference.

The present invention relates to a process for preparing chloromethyl di-tert-butylphosphate from potassium di-tert-butylphosphate and chloromethyl chlorosulfate under mild conditions in a one step procedure and to a process for preparing water-soluble azole antifungal agents employing chloromethyl di-tert-butylphosphate.

### BACKGROUND OF THE INVENTION

Mantyla, A. et al., “A novel synthetic route for the preparation of alkyl and benzyl chloromethyl phosphates”, Tet. Letters, 43 (2000) 3793-3794 discloses a synthesis for preparing various chloromethyl phosphates, namely, dibutyl, dibenzyl, diallyl and di-tert-butylchloromethyl phosphates, which are useful reagents for preparing phosphonooxymethyl prodrugs. The Mantyla et al. reaction scheme for the preparation of dialkyl and dibenzyl chlorophosphates is shown below 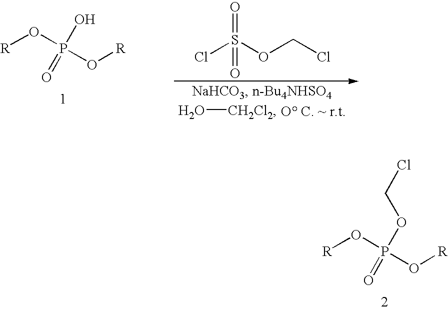
where R is

—CH₂CH₂CH₂CH₃,

—CH₂C₆H₅,

—CH₂CH═CH₂, or

—C(CH₃)₃.

Dialkyl or dibenzyl phosphate 1, sodium carbonate and tetra-n-butylammonium hydrogen sulfate are dissolved in water. Dichloromethane (DCM) is added and the mixture stirred at 0° C. followed by the addition of chloromethyl chlorosulfate in DCM with stirring overnight at room temperature to form the desired product 2.

U.S. Patent Publication No. 2002/0062028 A1 to Chen et al. discloses a process for preparing water-soluble azole antifungal compounds containing a secondary or tertiary hydroxy group which compounds have the formula 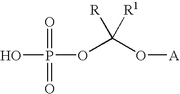
wherein A is the non-hydroxy portion of a triazole antifungal compound containing a secondary or tertiary hydroxy group and R and R¹ are each independently H or C₁₋₆ alkyl. The above compounds are prepared employing the following reaction scheme 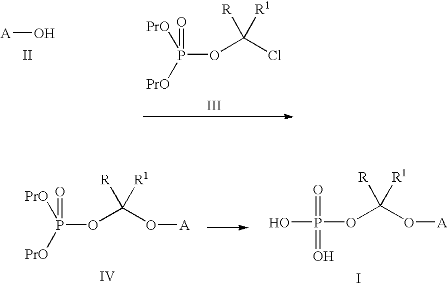
wherein Pr represents a hydroxy protecting group such as t-butyl, benzyl or allyl. As seen in the above reaction scheme the antifungal compound II is converted into phosphate intermediate IV by O-alkylation with chloride intermediate III in the presence of a suitable base such as sodium hydride and de-protection to remove hydroxy-protecting groups Pr to give product I.

Chen et al. disclose that the di-tert chloromethyl phosphate III may be prepared by any of the following three methods:

Method 1:

Silver di-t-butylphosphate is mixed with chloroiodomethane in benzene and stirred at room temperature to form compound III.

Method 2:

Tetrabutylammonium di-t-butylphosphate in benzene is added dropwise to stirred chloroiodomethane to form compound III.

Method 3:

To iodochloromethane is treated with tetrabutylammonium (added portionwise over 10 minutes) to form compound III.

### BRIEF DESCRIPTION OF THE INVENTION

In accordance with the present invention, a process is provided for preparing chloromethyl di-tert-butylphosphate which has the formula 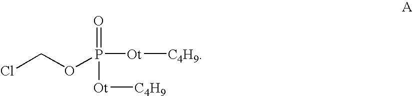
directly in one step from commercially available starting materials, namely potassium di-tert-butylphosphate 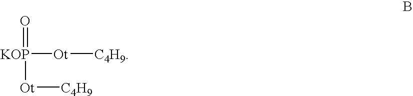
and chloromethyl chlorosulfate 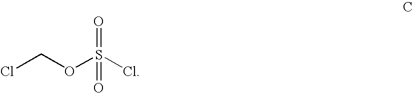
under substantially mild conditions and in high yield and good purity.

The process of the invention does not require employment of undesirable materials such as employed in prior art processes, namely unstable materials, such as 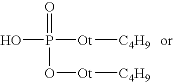
hygroscopic and costly 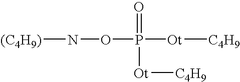
or cytotoxic materials such as
ClCH₂I
in large wasted excess, use of which requiring a difficult and tedious isolation. In addition, prior process produce low yields, that is less than 75% M, with product which may be contaminated with impurities.

The process of the present invention, on the other hand, employs commercially available potassium di-tert-butylphosphate (A) which is stable, non-hygroscopic and less expensive than 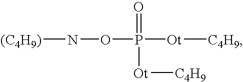
and is available in the form of a commercially available aqueous solution.

The chloromethyl chlorosulfate (B) starting material employed in the process of the invention is also commercially available, is non-cytotoxic, is used in a slight stoicheometric excess and is less expensive than ClCH₂I.

The yield of chloromethyl di-tert-butylphosphate product (A) produced in accordance with the process of the invention is between 88 to 92 M % with a potency of >90% and >95% material balance accounted for. The product is readily isolated via standard organic aqueous extraction and is used in processes to prepare water-soluble azole antifungal agents as disclosed in U.S. Patent Publication No. 2002/0062028 A1, the disclosure of which is incorporated herein by reference.

Thus, in accordance with the present invention, a process is provided for preparing the intermediate chloromethyl di-tert-butylphosphate A (used in preparing azole antifungal agents) having the structure 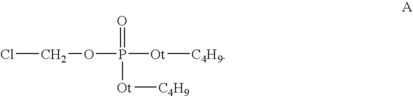
which includes the step of
reacting potassium di-tert-butylphosphate having the structure 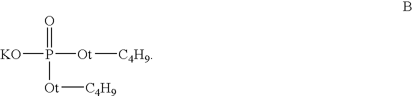
with chloromethyl chlorosulfate having the structure

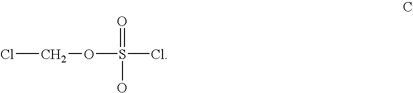

The process of the invention is preferably carried out in one step to form the intermediate A.

In a preferred embodiment, the process of the invention is carried out in the presence of a catalyst such as tetrabutylammonium sulfate or tetrabutylammonium chloride, a base such as sodium carbonate or potassium carbonate, in an organic solvent such as dichloromethane or tetrahydrofuran, at a temperature within the range from about 10 to about 30° C., preferably from about 15 to about 25° C.

### DETAILED DESCRIPTION OF THE INVENTION

In carrying out the process of the invention, the chloromethyl chlorosulfate (C) will be employed in a molar ratio to the potassium di-tert-butylphosphate (B) within the range from about 1.5:1 to about 3:1, preferably from about 1.9:1 to about 2.1:1.

The reaction will be preferably carried out in the presence of a catalyst such as tetrabutylammonium sulfate, tetrabutylammonium chloride, tetrabutylammonium bromide or tricaprylylmethylammonium chloride, preferably tetrabutylammonium sulfate or tetrabutylammonium chloride, employing a molar equivalent within the range from about 0.01 to about 1 equivalent, preferably from about 0.04 to about 0.06 equivalent, more preferably about 0.05 equivalent based on the staring material compound B.

The reaction will also be preferably carried out in the presence of a base such as an alkali metal carbonate such as sodium carbonate, potassium carbonate, lithium carbonate, an alkali metal alkoxide such as sodium alkoxide, potassium alkoxide or lithium alkoxide, alkali metal methoxide, alkali metal ethoxide, alkali metal propoxide or alkali metal butoxide, such as sodium methoxide, potassium methoxide, lithium methoxide, sodium ethoxide, potassium ethoxide, lithium ethoxide, sodium propoxide, potassium propoxide, lithium propoxide, sodium t-butoxide, potassium t-butoxide, lithium t-butoxide, sodium hydride, potassium hydride, pyridine, triethylamine, N,N-diethylamine, N,N-diisopropylamine, N,N-diisopropylethylamine (Hunig's base), 1,8-diazabicyclo[5.4.0]undec-7-ene (DBU), 1,5-diazabicyclo[4.3.0]non-5-ene (DBN), or 1,4-diazabicyclo[2.2.2]octane (DABCO), KHCO₃, NaHCO₃, BaCO₃, CaCO₃, C₂CO₃, MgCO₃, KOH, NaOH, or LiOH, preferably sodium carbonate or potassium carbonate.

The base will be employed in an amount within the range from about 3 to about 5 molar equivalents, preferably about 4 molar equivalents relative to compound B.

The reaction will be carried out in the presence of an organic solvent such as dichloromethane, tetrahydrofuran, toluene, chloroform, acetonitrile, methyl acetate, ethyl acetate, isopropyl acetate, propyl acetate, butyl acetate, acetone, methyl isobutyl ketone, methyl ethyl ketone, 1,2-dimethyoxyethane, 2-methyltetrahydrofuran, 1,4-dioxane, methyl t-butyl ether (MTBE), chlorobenzene, xylenes, heptane, hexanes, cyclohexane, cyclohexanone, DMF, dimethyl sulfoxide, N-methylpyrrolidinone, MTBE, methanol, ethanol, isopropanol, n-propanol, n-butanol, t-butanol, or ethylene glycol, preferably dichloromethane or tetrahydrofuran.

The organic solvent will be employed in an amount within the range from about 3 to about 15 mL/g of reaction mixture (B and C), preferably from about 5 to about 10 ml/g reaction mixture (B and C).

The reaction will also be carried out in the presence of water in an amount within the range from about 3 to about 15 mL/g reaction mixture (B and C), preferably from about 5 to about 10 mL/g reaction mixture (B and C).

The reaction of B and C is carried out under relatively mild conditions at a temperature within the range from about 10 to about 30° C., preferably from about 15 to about 25° C., for a period to ensure yields of at least 85%, and yields of 88 to 92M %, >90% potency.

The chloromethyl di-tert-butylphosphate product A of the process of the invention may be employed as reactant III which is reacted with reactant II (A-OH where A represents the non-hydroxy portion of a triazole antifungal compound of the type containing a tertiary hydroxy group) as disclosed in U.S. Patent Publication, U.S. 2000/0062028 A1 which is incorporated herein by reference.

The following working Example represents a preferred embodiment of the invention.

### EXAMPLE

### Preparation of Chloromethyl Di-tert-Butylphopshate

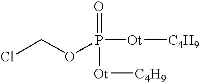 The following ingredients were combined in a vented glass reactor
(C₄H₉)₄NHSO₄ (0.05 eq) (catalyst)
Na₂CO₃ (4.00 eq) (base)
KOP(O)(OtC₄H₉)₂ (1.00 eq) (reactant B)

Water was added to bring the aqueous volume to 7.5 mL per gram activity of input.

CH₂Cl₂ was added as a solvent (7.5 mL per gram activity of input). To the resulting reaction mixture maintained at about 18° C. was added chloromethyl chlorosulfate (2.00 eq) and the reaction mixture was agitated vigorously for 4.5 hours at 18° C.

The reaction was worked up as follows.

Water was added to the reaction mixture (12 mL per gram activity of input) and the solution was stirred to dissolve the solids.

The resulting organic and aqueous phases were separated and the spent aqueous phase was then backwashed with CH₂Cl₂ (about 2 mL per gram activity input). The phases were separated and the organic splits were combined and the aqueous volume recorded. The aqueous phase was sampled to quantify the unreacted starting material via ³¹P NMR.

The rich organic phase was washed with water (7.5 mL per gram activity input) and the phases were separated so that the rich organic phase was free of water. The rich organic phase was distilled (moderate vacuum, 20° C. jacket) to remove CH₂Cl₂ and obtain the product rich oil. The weight of product oil was recorded and potency was obtained by sampling for ³¹P NMR. The productivity was reported as M % activity yield. The product oil was stored in the freezer (←5° C.).

An 11.0 g (activity) input reaction yielded 11.3 g of product oil with a potency of 91.9% (via ³¹P NMR int. std.). This gives an M % activity yield to product of 90.9%. The unreacted starting material in the reaction aqueous phase was 3.3M % (via ³¹P NMR int. std.).

¹H NMR revealed about 5 mol % residual (C₄H₉)₄NHSO₄ present in the product oil.

What is claimed is:

1. A process for preparing an intermediate compound of the structure 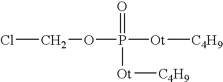
which comprises
reacting a compound of the structure 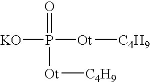
with a compound of the structure 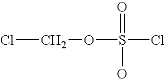
to form the intermediate compound.

2. The process as defined in claim 1 which is carried out in one step to form the intermediate compound.

3. The process as defined in claim 1 wherein the reaction is carried out in the presence of a catalyst under mild conditions.

4. The process as defined in claim 3 wherein the reaction is carried out in the presence of a base and an organic solvent.

5. The process as defined in claim 3 wherein the catalyst is tetrabutylammonium sulfate, tetrabutylammonium chloride, tetrabutylammonium bromide or tricaprylylmethylammonium chloride.

6. The process as defined in claim 5 wherein the catalyst is tetrabutylammonium sulfate or tetrabutylammonium chloride.

7. The process as defined in claim 1 wherein the reaction is carried out at a temperature within the range from about 10 to about 30° C.

8. The process as defined in claim 4 wherein the base is sodium carbonate or potassium carbonate, and the organic solvent is dichloromethane or tetrahydrofuran.

9. A process for preparing a compound of the structure 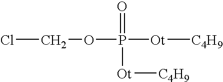
which comprises
reacting a compound of the structure 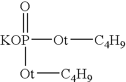
with a compound of the structure 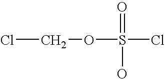
in the presence of a base, a catalyst, an organic solvent and water, at a temperature within the range from about 15 to about 25° C.

10. The process as defined in claim 9 wherein the base is sodium carbonate or potassium carbonate, the catalyst is tetrabutylammonium sulfate or tetrabutylammonium chloride and the organic solvent is dichloromethane or tetrahydrofuran.

11. The process as defined in claim 9 carried out in a single step procedure.

12. A process for preparing an azole antifungal agent employing chloromethyl di-tert-butylphosphate prepared as defined in claim 1.
